(19) United States
(12) Patent Application Publication
(10) Pub. No.: US 2013/0139386 A1
(43) Pub. Date: Jun. 6, 2013

(54) HONEYCOMB CONSTRUCTION FOR ABRADABLE ANGEL WING

(71) Applicants: Benjamin Paul LACY, Greer, SC (US); Raymond CHUPP, Greenville, SC (US); Nuo SHENG, Niskayuna, NY (US)

(72) Inventors: Benjamin Paul LACY, Greer, SC (US); Raymond CHUPP, Greenville, SC (US); Nuo SHENG, Niskayuna, NY (US)

(73) Assignee: General Electric Company, Schenectady, NY (US)

(21) Appl. No.: 13/312,109

(22) Filed: Dec. 6, 2011

(51) Int. Cl. B23H 1/00; B23H 9/00; B23P 15/00

(52) U.S. Cl. 29/888.3; 29/527.2; 219/69.17

(57) ABSTRACT

An abradable honeycomb is integrally formed in a turbine nozzle sealing flange for engagement with a bucket angel wing to reduce the leakage of air into the turbine's hot gas path. The honeycomb is integrally formed in a turbine nozzle sealing flange using a sinker EDM method to directly sink the honeycomb into the sealing flange itself, so that the honeycomb is an integral part of the flange. For repair, an entirely new honeycomb flange can be made and welded or brazed on to the turbine nozzle.

The present invention relates to turbines, and more particularly, to a method of fabricating an abradable honeycomb as an integral part of a nozzle sealing flange which is engaged by an angel wing of a rotating bucket in a gas turbine to limit cooling air from leaking into the gas turbine's high temperature combustion gas passage.

This invention was made with Government support under contract number DE-FC26-05NT42643 awarded by the Department Of Energy. The Government has certain rights in this invention.

### BACKGROUND OF THE INVENTION

A gas turbine is a rotary engine that extracts energy from the flow of combustion gas through the turbine. It has an upstream air intake or inlet, a compressor coupled to a combustor, a downstream turbine that receives combustion gas from the combustor, and a gas outlet or exhaust nozzle.

The compressor and turbine sections include at least one circumferential row of rotating rotor blades or buckets. The free ends or tips of the buckets are surrounded by a stator casing. The base portions of the rotor blades are flanked by the inner shrouds of stator blades or nozzles located upstream and downstream of the rotating buckets.

Seal assemblies are typically used to prevent or limit cooling air from leaking into a gas turbine's high temperature combustion gas passage from between moving buckets and stationary nozzles. These seal assemblies typically include seal plates, referred to as “angel wings”, which extend axially from the upstream and downstream surfaces of the shank portions of the moving buckets, and which terminate in radially outwardly extending tips or teeth. The seal assemblies also include sealing structures or flanges projecting axially from upstream and downstream from stationary nozzle assemblies to define seals with the angel wings of the moving bucket shanks. However, the sealing performance of these seal assemblies is not always good, such that more than a desired amount of the cooling air tends to leak into the high temperature combustion gas passage so that the amount of cooling air is increased, causing deterioration in the performance of the gas turbine.

The efficiency of the turbine depends, in part, on the radial clearance or gap between the angel wings and the adjacent sealing structures. If the clearance is too small, the angel wings will strike the adjacent sealing structures during certain turbine operating conditions. If the clearance is too large, excessive valuable cooling air will leak from the rotor wheelspace into the hot gas path, decreasing the turbine's efficiency.

An abradable seal can be used to improve turbine performance by physically reducing the clearance between the sealing flange of a nozzle and an opposed angel wing seal plate of a bucket. An abradable seal material is sometimes located on the radially inner surface of the seal of the stationary nozzle, so as to be located within the annular gap between the inner surface of the nozzle seal and the end tips of the angel wing of the rotating bucket.

One type of sealing material that is used in sealing assemblies is an abradable honeycomb. While an abradable honeycomb has the ability to significantly reduce the leakage of cooling air into the high temperature combustion gas passage, the secure attachment of traditionally made abradable honeycomb pieces at a bucket/nozzle interface is difficult to ensure.

Angel wing abradable seals using honeycomb on the nozzle have been shown to provide significant sealing improvement. However, attaching a honeycomb piece reliably to an angel wing is difficult, since brazing thin pieces of metal ribbon means a very small attachment region. Currently, the honeycomb is sometimes brazed directly to a part with the hope that it will stay on. One alternative to this is to braze the honeycomb to a plate and then braze or weld the plate onto the angel wing.

### BRIEF DESCRIPTION OF THE INVENTION

The present invention uses sinker electrical discharge machining (“EDM”) to plunge/burn a honeycomb directly into a turbine nozzle sealing flange so it becomes an integral part of the nozzle sealing flange so that when a turbine bucket angel wing in the turbine's sealing assembly rubs the nozzle sealing flange, there is improved sealing between the nozzle sealing flange and the bucket angel wing with less risk of honeycomb failure. Optionally, the honeycomb resulting from the electrode with the sinker electrical discharge machining device being plunged into the block of material can be coated with a coating suitable for corrosion resistance and/or improved abradability. In addition, the block of material in which the honeycomb is formed can be either an integral part of the turbine nozzle or separate from the turbine nozzle. In the latter case, the block of material is welded or brazed to the turbine nozzle after the honeycomb has been formed in such block.

In an exemplary embodiment of the invention, a method of making a turbine nozzle sealing flange with a plurality of abradable cavities formed in the sealing flange comprises the steps of providing a block of material suitable for serving as a nozzle sealing flange, providing a sinker electrical discharge machining device for machining features into the block of material, providing an electrode for use with the sinker electrical discharge machining device to perform the machining of the features in the block of material, the electrode being shaped to form the plurality of cavities in the block of material, and using the electrode with the sinker electrical discharge machining device to plunge the electrode directly into the block of material, to thereby form the nozzle sealing flange with the plurality of abradable cavities.

In another exemplary embodiment of the invention, a method of limiting cooling air from leaking into a gas turbine's high temperature combustion gas passage comprises the steps of providing one or more blocks of material suitable for forming one or more corresponding turbine nozzle sealing flanges, providing a sinker electrical discharge machining device for machining features into the block(s) of material, and providing an electrode for use with the sinker electrical discharge machining device to perform the machining of the features into the block(s) of material, the electrode having a series of crisscrossing negative grooves which form a positive honeycomb pattern that can be formed directly into the block(s) of material by the positive electrode burning the honeycomb pattern into each of the one or more blocks of material when the electrode is pressed into the block of material.

In a further exemplary embodiment of the invention, a method of making a part with a predetermined integral abradable shape comprises the steps of providing a block of material suitable for making the part, providing a sinker electrical discharge machining device for machining features into the block of material, providing an electrode for use with the sinker electrical discharge machining device to perform the machining of the features in the block of material, the electrode being shaped to form the predetermined shape in the block of material, using the electrode with the sinker electrical discharge machining device to burn the predetermined integral abradable shape directly into the block of material, and optionally coating the resulting predetermined integral abradable shape burned into the block of material with a coating suitable for corrosion resistance and/or improved abradability.

### BRIEF DESCRIPTION OF THE DRAWINGS

FIG. 1 illustrates the concept of attaching a abradable honeycomb seal to an angel wing to seal the path into a turbine hot gas path from the wheelspace.

FIGS. 2A and 2B are perspective views of two embodiments of an abradable angel wing seal in which is directly formed the abradable honeycomb so as to be an integral part of the angel wing seal.

FIG. 3 is an enlarged perspective view of a portion of the abradable honeycomb formed in an angel wing seal according to the present invention.

FIG. 4 is a sketch depicting the multiple layers resulting from the honeycomb being coated with a material for corrosion resistance/improved abradability.

FIG. 5 is an enlarged perspective view of a sketch depicting the preferable diamond shape of each of the hexagonal cells comprising the abradable honeycomb formed in an angel wing seal according to the present invention.

FIG. 6 is a simplified sketch of a Sinker EDM (Electrical Discharge Machining) machine used in the process of making the honeycomb impression formed in an angel wing seal according to the present invention.

FIG. 7 is an enlarged perspective view of an electrode used in the Sinker EDM machine to make the honeycomb impression formed in an angel wing seal according to the present invention.

### DETAILED DESCRIPTION OF THE INVENTION

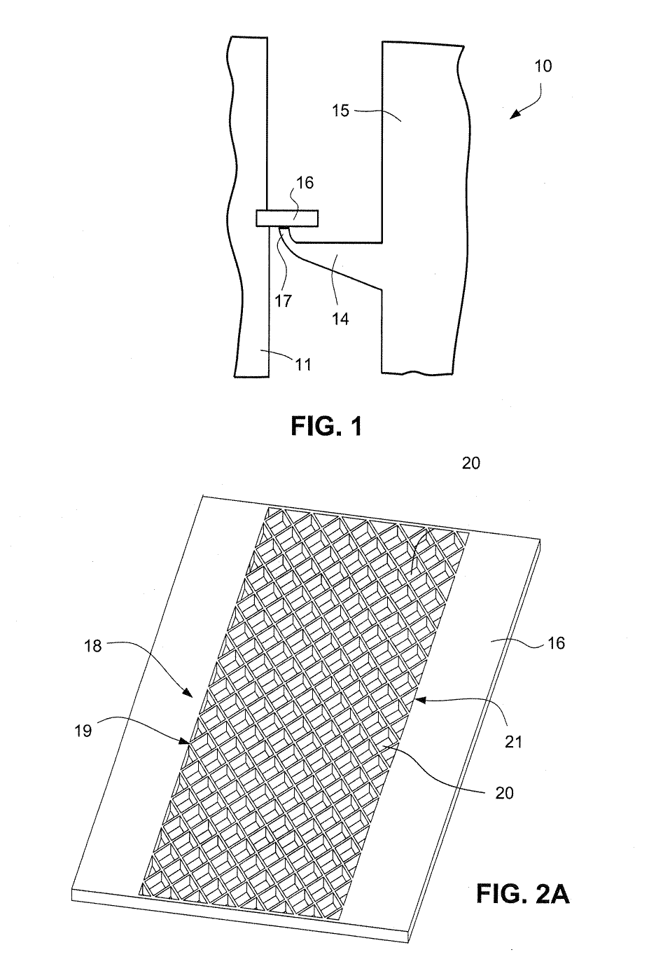

FIG. 1 is a simple cross-sectional view showing a part of a seal assembly 10 for limiting cooling air from leaking from between a moving bucket 15 and a stationary nozzle 11 of a gas turbine (not shown) into the high temperature combustion gas passage of the turbine. The turbine has a rotor (not shown) rotating about a center longitudinal axis and a plurality of buckets 15 mounted on the outer surface of the rotor. The buckets are spaced from one another circumferentially around the rotor. The buckets 15 also extend radially outward from the rotor. A stationary outer casing (not shown) surrounding and spaced radially outwardly from the buckets defines the high temperature gas passage through the turbine.

Seal plates, typically referred to as “angel wings” 14, extend axially from the upstream and downstream surfaces of the shank portions of the rotating buckets 15. Each of the angel wings 14 ends in a radially outwardly extending tip or cutter tooth 17. Sealing structures or flanges 16 project axially from upstream and downstream stationary nozzle assemblies 11 for defining seals with the angel wings 14 of the rotating buckets 15. The seal assemblies 12 and 14 are intended to limit the amount of cooling air from leaking into the high temperature combustion gas passage.

FIG. 1 illustrates the concept of a sealing flange 16 with an abradable honeycomb being attached to a nozzle 11 and engaged by a cutter tooth 17 on an angel wing 14 to thereby seal the path into the hot gas path. The seal between the honeycomb in sealing flange 16 and the cutter tooth 17 on the angel wing 14 reduces leakage. However, because the location of sealing flange 16 is a high g force and a high temperature location and variances can result in varying amounts of rub, ensuring reliable attachment of traditional thin honeycomb foil to plate 16 is difficult.

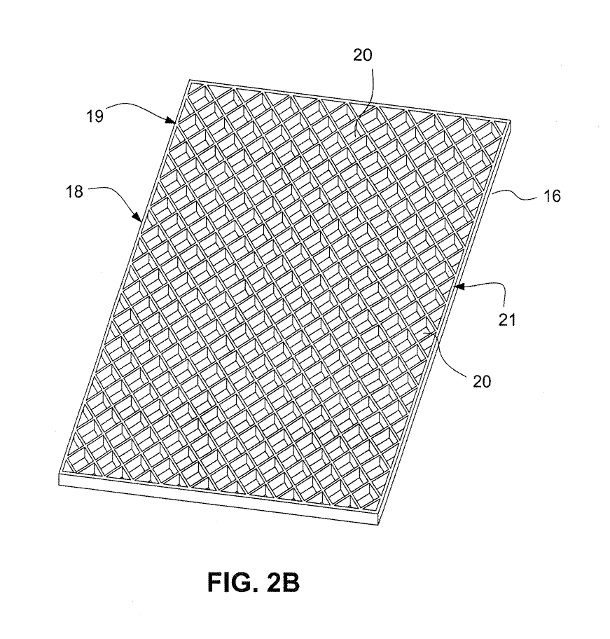

FIGS. 2A and 2B are perspective views of sealing flange 16 with a abradable honeycomb 18 directly plunged into the nozzle sealing flange itself, so that the honeycomb 18 is an integral part of the nozzle sealing flange. The honeycomb 18 being an integral part of the sealing flange 16 is advantageous because this construction allows for faster and better repairs of worn out abradable honeycomb seals. The honeycomb 18 can be integrally formed in a sealing flange that is integral to the angel wing 14 or in a new or replacement sealing flange 16 that is separate from the angel wing 14. Where the sealing flange 16 with the integrally formed honeycomb 18 is separate from the angel wing 14, it can then be welded, brazed or attached mechanically to the angel wing 14. The honeycomb 18 can extend to all sides of the nozzle sealing flange or to only some (e.g., two) of the sides of the nozzle sealing flange, as shown in FIGS. 2A and 2B.

After the honeycomb 18 has been formed, it can optionally be coated with a coating suitable for oxidation and corrosion resistance and/or improved abradability. An example of such a coating would be an aluminide intermetallic coating.

It should be noted that although FIG. 2 preferably shows a honeycomb 18 with a plurality of cells formed in the nozzle sealing flange 16, other abradable patterns, which include a plurality of cavities interconnected by a plurality of side walls, could be formed in the sealing flange 16. These cavities could be similar to, or different from, the cells 20 of honeycomb 18, for example, in shape and/or construction.

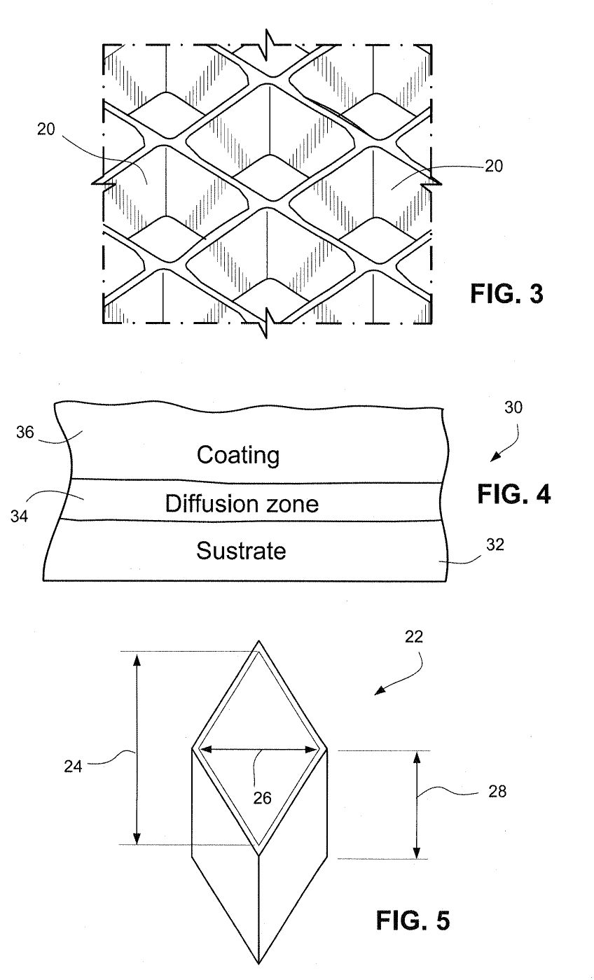

FIG. 3 is an enlarged perspective view of a portion of the abradable honeycomb 18 formed in sealing flange 16 according to the present invention. FIG. 4 depicts a portion 30 of a single honeycomb cell 20 that has been coated with a coating 36 possibly for corrosion resistance and/or improved abradability, such that the result is the substrate material 32 from which the sealing flange 16, and thus the honeycomb 18 is formed, has a diffusion zone 34 between itself and the coating 36. One example of a substrate material is inconel. “Inconel” is a registered trademark for a family of austentic nickel-chromium-based superalloys that are typically used in high temperature applications.

As can be seen from FIG. 3, preferably, each of the individual cells 20 forming the honeycomb 18 are diamond shaped hexagons, although it should be noted that other suitable geometric shapes could be used. FIG. 5 is an enlarged perspective view of a sketch depicting the preferable diamond shape of each of the hexagonal cells comprising the abradable honeycomb 18 formed in sealing flange 16. The dimensions of the cells 20 can be of any size and any wall thickness. Preferably, the goal dimensions for the diamond shaped cells 20 are a length of between 0.05 and 0.2 inches, a width of between 0.05 and 0.1 inches, a depth of about 0.1 to 0.6 inches, and a wall thickness of about 0.004 to 0.015 inches.

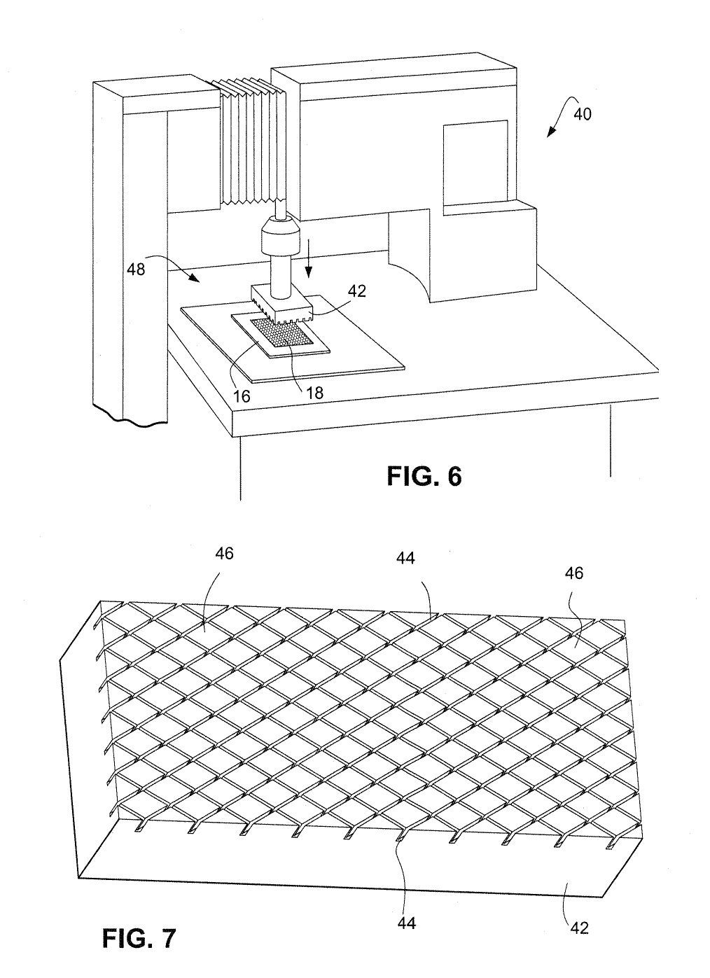

FIG. 6 is a simplified sketch of a Sinker EDM (Electrical Discharge Machining) machine 40 used in the process of making a honeycomb impression 18 integrally formed in sealing flange 16 according to the present invention. FIG. 7 is an enlarged perspective view of an electrode 42 used in the Sinker EDM machine 40 to press the honeycomb impression 18 in a sealing flange 16 according to the present invention. The electrode 42 includes a series of crisscrossing “negative” grooves 44 in it which form a “positive” diamond shaped pattern that is used to press the diamond shaped honeycomb 18 in a sealing flange 16. The Sinker EDM machine 40 then includes a press assembly on which the electrode 42 is mounted to press the honeycomb 18 directly into the sealing flange 16, as shown in FIG. 6. Using the Sinker EDM machine 40 to directly sink the diamond honeycomb 18 into the sealing flange 16 allows the honeycomb to become an integral part of the sealing flange 16. In this regard, casting for sealing flange 16 could be thickened to allow pressing the honeycomb 18 directly into the flange at any desired location, after which a coating can be added. For repair, or as an alternative for new construction, an entire sealing flange 16 can have the honeycomb 18 sunken into it, which can then be welded, brazed, or mechanically attached to the nozzle 11.

Thus, FIG. 6 shows the process for making a sealing flange 16 with an integral honeycomb 18 of appropriate dimensions and size. A sinker electrode 42, like that shown in FIG. 7, is first formed and then plunged into the sealing flange the honeycomb is to go into. One possibility would be a block of inconel to be used as the sealing flange 16. Diamond or square shapes are easiest to make though with more complex machining of an electrode like electrode 42, more complex shapes can be made. Dimensions can easily be varied.

Sinker EDM (Electrical Discharge Machining) is a process that lends itself to precision machining of features when conventional machining is inappropriate. For instance, complex features, small precise features and tight tolerance features are all examples of operations well suited for sinker EDM, in which a “positive” shaped electrode can be machined and then “sunk” (burned) into a desired part. With EDM, no pressure is applied to the material being machined, as the features are burned to their shape, rather than abraded. A more complicated electrode shape than the diamond shaped honeycomb of the electrode 42 shown in FIG. 7 could do either a more complicated honeycomb pattern or other, more complicated patterns.

In one alternative embodiment, a thicker sidewall along the leading edge 19 and/or the trailing edges 21 (where no rub occurs) could be retained to improve strength. Additional embodiments could include the formation of varied shapes and sizes. The EDM technology enables having certain walls thicker in one axis or location than another, which could allow improved sealing, while not impacting abradability (thicker in the flow direction, than in the rub direction, for example). The EDM technology can also enable angling of the honeycomb in a preferred direction, again to improve sealing. The thickness of honeycomb could be varied in one direction versus another preferential direction. The sunken shape, such as a honeycomb, could also have another non-normal orientation that could not easily be made any other way.

The use sinker electrical discharge machining (“EDM”) to directly plunge the honeycomb 18 into the nozzle sealing flange 16 itself, so that the honeycomb becomes an integral part of the nozzle sealing flange, enables the abradable angel wing seal by providing a reliable method for putting honeycomb on a nozzle sealing flange. It also results in a sealing flange that provides improved sealing between the angel wing and the sealing flange.

The use of the sinker electrical discharge machining enables a new sealing technology may have applications in other turbine locations, as well in other areas of application.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of making a turbine nozzle sealing flange with a plurality of abradable cavities interconnected by a plurality of side walls formed in the sealing flange, the method comprising the steps of:
providing a block of material suitable for serving as a nozzle sealing flange,
providing a sinker electrical discharge machining device for machining features into the block of material, providing an electrode for use with the sinker electrical discharge machining device to perform the machining of the features in the block of material, the electrode being shaped to form in the block of material the plurality of interconnected cavities, and
using the electrode with the sinker electrical discharge machining device to plunge the electrode directly into the block of material, to thereby form the nozzle sealing flange with the plurality of interconnected cavities.

2. The method of claim 1 further comprising the step of coating the plurality of interconnected cavities with a coating suitable for oxidation and corrosion resistance and/or improved abradability.

3. The method of claim 1, wherein the block of material in which the plurality of interconnected cavities are formed is separate from the turbine nozzle, and wherein the method further comprises the step of welding or brazing the block of material to the turbine nozzle after the plurality of interconnected cavities have been formed in such block.

4. The method of claim 1, wherein the block of material in which the plurality of interconnected cavities are formed is an integral part of the turbine nozzle.

5. The method of claim 1, wherein the plurality of interconnected cavities form a honeycomb shape, and wherein each cell of the honeycomb has a length and a width that results in the cell having a diamond shape.

6. The method of claim 1, wherein the plurality of interconnected cavities form a honeycomb shape, and wherein each cell of the honeycomb has dimensions that result in the cell having a shape other than a diamond shape.

7. The method of claim 1, wherein the block of material is formed from an austentic nickel-chromium-based alloy.

8. The method of claim 1, wherein the electrode is positive shaped so that the plurality of interconnected cavities can be sunk into the block of material, and wherein the plurality of interconnected cavities are sunk into the block of material by the positive electrode burning the shape of the plurality of interconnected cavities into the block of material.

9. The method of claim 1, wherein the plurality of cavities form a honeycomb shape, and wherein each cell of the honeycomb has a length of between 0.05 and 0.2 inches, a width of between 0.05 and 0.1 inches, a depth of about 0.1 to 0.6 inches, and a wall thickness of about 0.004 to 0.015 inches

10. The method of claim 1, wherein the electrode has a series of crisscrossing negative grooves which form a positive diamond shaped honeycomb pattern that is burned into the block of material when the electrode is pressed into the block of material.

11. The method of claim 8, wherein the sinker electrical discharge machining device includes a press assembly on which the electrode is mounted to press the electrode into the block of material to thereby burn the plurality of interconnected cavities directly into block of material.

12. The method of claim 1, wherein the plurality of interconnected cavities are formed with a sidewall along the leading edge and/or the trailing edge of the plurality of interconnected cavities to improve strength in the sealing flange.

13. The method of claim 1, wherein the plurality of plurality of interconnected cavities are formed with walls thicker in a first direction than in a second direction, to thereby improve sealing between the nozzle sealing flange and a turbine bucket angel wing in the turbine's sealing assembly, when the nozzle sealing flange is in the sealing assembly.

14. The method of claim 1, wherein the plurality of plurality of interconnected cavities are formed with thicker walls in the direction that cooling air flows into the turbine's high temperature combustion gas passage, rather than in the direction a turbine nozzle angel wing in the turbine's sealing assembly rubs the nozzle sealing flange, when the nozzle sealing flange is in the sealing assembly, to thereby improve sealing between the nozzle sealing flange and the bucket angel wing.

15. The method of claim 1, wherein the plurality of plurality of interconnected cavities are formed in the sealing flange so as to be angled in a predetermined direction, to thereby improve sealing between the nozzle sealing flange and the bucket angel wing.

16. The method of claim 1, wherein the plurality of plurality of interconnected cavities formed in the block of material extend to all sides of the block of material or to only some of the sides of the block of material.

17. The method of claim 2, wherein the coating is an aluminide intermetallic coating.

18. A method of limiting cooling air from leaking into a gas turbine's high temperature combustion gas passage, the method comprising the steps of:
providing one or more blocks of material suitable for forming one or more corresponding turbine nozzle sealing flanges,
providing a sinker electrical discharge machining device for machining features into the block(s) of material,
providing an electrode for use with the sinker electrical discharge machining device to perform the machining of the features into the block(s) of material, the electrode having a series of crisscrossing negative grooves which form a positive honeycomb pattern that can be formed directly into the block(s) of material by the positive electrode burning the honeycomb pattern into each of the one or more blocks of material when the electrode is pressed into the block of material.
using the electrode with the sinker electrical discharge machining device to form the honeycomb directly into each of the one or more blocks of material,
optionally coating the resulting honeycomb formed directly into each of the one or more blocks of material with a coating suitable for oxidation and corrosion resistance and/or improved abradability, to thereby form one or more corresponding nozzle sealing flanges with the abradable honeycomb formed integrally in the nozzle sealing flanges, and
providing one or more turbine sealing assemblies in which the one or more corresponding nozzle sealing flanges with integral abradable honeycombs are engaged by corresponding bucket angel wings,
whereby the cooling air leaking into the gas turbine's high temperature combustion gas passage is limited.

19. The method of claim 18, wherein at least one of the block(s) of material in which the honeycomb(s) is formed is separate from the turbine nozzle, and wherein the method further comprises the step of welding or brazing the block of material to the nozzle after the honeycomb has been formed in such block.

20. The method of claim 18, wherein at least one of the block(s) of material in which the honeycomb is formed is an integral part of the turbine nozzle.

21. The method of claim 18, wherein the electrode has a series of crisscrossing negative grooves which form a positive diamond shaped honeycomb pattern that can be formed directly into the block of material by the positive electrode burning the diamond shaped honeycomb pattern in the block of material when the electrode is pressed into the block of material.

22. The method of claim 21, wherein the sinker electrical discharge machining device includes a press assembly on which the electrode is mounted to press the electrode into the block(s) of material to thereby burn the honeycomb directly into the block(s) of material.

23. The method of claim 18, wherein the coating is an aluminide intermetallic coating.

24. A method of making a part with a predetermined integral abradable shape, the method comprising the steps of:
providing a block of material suitable for making the part,
providing a sinker electrical discharge machining device for machining features into the block of material,
providing an electrode for use with the sinker electrical discharge machining device to perform the machining of the features in the block of material, the electrode being shaped to form the predetermined shape in the block of material,
using the electrode with the sinker electrical discharge machining device to burn the predetermined integral abradable shape directly into the block of material, and
optionally coating the resulting predetermined integral abradable shape burned into the block of material with a coating suitable for oxidation and corrosion resistance and/or improved abradability.
